(19) United States
(12) Patent Application Publication
(10) Pub. No.: US 2008/0112677 A1
(43) Pub. Date: May 15, 2008

(54) Optical Display System and Method

(76) Inventor: Ronald Smith, Palm Bay, FL (US)

Correspondence Address: CARL M. NAPOLITANO, PH.D.;ALLEN, DYER, DOPPELT, MILBRATH & GILCHRIST, P.A., 255 SOUTH ORANGE AVE., SUITE 1401, P.O. BOX 3791, ORLANDO, FL, 32802-3791, US

(21) Appl. No.: 11/765,577

(22) Filed: Jun. 20, 2007

Related U.S. Application Data
(60) Provisional application No. 60/805,410, filed on Jun. 21, 2006.

(51) Int. Cl. G02B 6/06; G02B 6/30

(52) U.S. Cl. 385/119; 385/49

(57) ABSTRACT

An optical display system includes an image generator providing discrete anamorphic picture elements to form an image, with each picture element spatially compressed along only a short dimension. A fiber optic array magnifier extends from the image generator and includes optical fibers dimensioned for optically coupling to each discrete anamorphic picture element. An output face of the array magnifier is bias-cut for magnifying the image along the short dimension. A light redirecting structure includes layered arcuate waveguide slabs optically coupled to the array magnifier with each of the arcuate waveguide slabs optically coupled to the array magnifier. A screen is integrally formed with the light redirecting structure and includes tapered slab waveguide portions positioned between light absorbing material having a saw tooth styled edge for providing multiple scattering and thus multiple absorption of ambient light incident upon the screen.

### CROSS-REFERENCE TO RELATED APPLICATIONS

This application claims the benefit of U.S. Provisional Application No. 60/805,410 for Light Guide Imager with Integral Light Redirecting Structure and Screen, the disclosure of which are hereby incorporated by reference herein in its entirety, and all commonly owned.

### FIELD OF INVENTION

The present invention generally relates to optical waveguides, and in particular to a light guide imager useful with large format displays and flat panel displays.

### BACKGROUND

Display devices having large format capabilities are well known. Such device technologies include Plasma Display Panels (PDP), Liquid Crystal Display (LCD) panels, Surface-conduction Electron-emitter Display (SED) panels, and Organic Light Emitting Diode (OLED) panels. Even the venerable direct-view Cathode Ray Tube (CRT) is available in large format configurations. Additionally, small display devices may be optically projected, either from the front or rear of a viewing screen, to achieve a large format capability. Commonly applied projection display technologies include Digital Micro-mirror Devices (DMD), sometimes called Digital Light Processing (DLP), Liquid Crystal (LC) transmission-type light valves, Liquid Crystal On Silicon (LCOS) reflective light valves, Cathode Ray Tube (CRT) projection, and Light Amplification by Stimulated Emission of Radiation (LASER) projection.

The myriad display technologies presently extant each exhibit their respective strengths and weaknesses. For example, self-emissive phosphor-based technologies such as CRT, PDP, and SED can achieve exceptional optical dynamic range and contrast when viewed in reduced ambient light conditions, but perform much less acceptably in medium-to-high ambient light environments because of re-radiation and reflection of ambient light from the phosphors. Conventional panel-type technologies such as PDP and LCD are, in general, characterized by complex on-panel active-switching optoelectronic elements. When even a small number of these elements are manufactured incorrectly or fail, high scrap costs can result, simply from the loss of significant amounts of valuable materials present in a large format panel. The panel-type displays, however, can deliver the very desirable characteristic of a thin, compact form factor. The projection technologies, in contrast, typically use much smaller amounts of expensive active switching materials, but they also often use precision lenses, special light-gathering optics, mirrors, and screens. Projection systems furthermore contend with high optical power densities incident on the small-area image generating element. If reliability is to be maintained, robust and sometimes expensive components are needed. Additionally, most projection systems do not exhibit the characteristic of a thin, compact form factor. Large format projection display systems are often slightly less expensive than their panel-type display counterparts, but may suffer market acceptance difficulties because of a less-desirable form factor.

Efforts have been made to reduce the thickness of rear projection displays over a period of several decades. Many of these efforts have utilized some form of fiber optic coupling of a large screen element to a small image generator element. Representative patents addressing this technique include the Crawford, U.S. Pat. No. 3,402,000; Glenn, Jr., U.S. Pat. No. 4,209,096; Higuchi, U.S. Pat. No. 6,031,954; and Smith, U.S. Pat. No. 6,326,939. These devices use various schemes wherein bundles of essentially cylindrical light guides are manipulated to obtain a magnifying effect. Significant efforts by Veligdan, et al as exemplified in U.S. Pat. Nos. 5,381,520; 5,625,736; 5,668,907; 6,002,826; and 6,301,417 have been directed toward the use of slab-type optical waveguides in thin display configurations. However, since this technology constrains light along only one directional axis, ancillary optical techniques are typically required to maintain focus and geometric integrity at the output screen plane as is evidenced by Cotton, et al U.S. Pat. Nos. 6,719,430; 6,715,886 and Beiser U.S. Pat. Nos. 6,328,448; 6,012,816.

Fiber Optic projection display systems have not as yet achieved significant commercial success. Probable contributing elements to this lack of success are factors such as optical architectures that are not well-adapted to low-cost, high-volume production techniques, inefficient light transfer due to poor optical fill-factor of some fiber configurations, high optical power density considerations at the input aperture, expensive ancillary illumination and imaging optics, and inferior image quality and contrast associated with some of the architectures.

### SUMMARY

The present invention is directed to light guide imaging and compactly providing one-dimensional magnification for pre-distorted optical inputs. One embodiment of the invention may include an optical display system comprising an array magnifier having a plurality of anamorphic fiber optic light guides extending from an input face to an output face of the array magnifier. The input face may be dimensioned for optically coupling to an image generator providing a plurality of discrete anamorphic picture elements thereto, wherein each picture element is defined by a short dimension and a long dimension, and wherein each of the plurality of light guides is generally aligned along corresponding long and short axes. The array magnifier further includes a bias-cut output face such that each fiber optic light guide is modified along the short dimension so as to provide a one-dimensional magnification to each of the anamorphic picture elements. A light redirecting structure having a plurality of arcuate waveguide slab elements arranged in a layered manner and extending from a first end optically coupled to the output face of the array magnifier, wherein each of the plurality of arcuate waveguide slab elements extends so as to receive an image from the image generator as modified by the array magnifier. Each may be dimensioned for optically coupling to the plurality of fiber optic light guides. The light redirecting structure may further include an output face formed by the plurality of arcuate waveguide slab elements.

Another embodiment may include an imager having an anamorphic input image generator, an array of high-aspect-ratio optical fibers including a bias cut, means for optical index matching, means for redirecting light, and a screen element for light distribution and ambient light suppression, by way of example. The means for redirecting light and the screen element may be integrated into a single structure.

By way of example, input configurations may include rectangular, non-square, output formats. A first input may be disposed along a long fiber optic array face or a second input disposed along a short fiber optic array face. The dimensions and aspect ratios of the optical fibers may be sized to accommodate the optical resolutions of the input image generator according to spatial Nyquist sampling requirements for a given image acuity. Rectangular, elliptical, and similarly shaped high-aspect-ratio light guides exhibit improved fill factors over shapes that are approximately rotationally symmetric.

Interstitial absorbing optical cladding structures may be employed within a fiber array to decrease pixel-to-pixel cross-talk and to improve general output image contrast. Light incident upon the fiber array input face may be polarized to optimize optical transmission at the output screen interface, and may be semi-collimated to reduce optical absorption within the optical fibers and to improve the contrast performance of light valves used as input image generators.

Magnification may be controlled by an output-face to input-face dimensional ratio. By way of example, one-dimensional magnifications may range from approximately 10 to 25 times. A light redirecting structure may be coupled to the output face of the bias cut optical fiber array with an index-matching means such as an optical gel or functionally similar material or process, and may be integrated with a screen structure.

One screen structure achieves high ambient light suppression by incorporating multiple-reflection light traps in conjunction with small fill-factor light emission apertures. Screen viewing angles may be controlled by the numerical aperture of the optical fibers, the light cone of illumination optics, and diffusive structures at the surface of the output aperture, within the screen aperture core, and/or at the coupling interface between the optical fiber array output face and the light redirector face. Embodiments of the invention including a light guide imager is suitable for use with several flat panel display illumination architectures and exhibits a very compact thickness form factor and high ambient light suppression.

Embodiments of the invention provide anamorphic picture elements and image generator used in combination with a single-axis fiber optic magnifier having anamorphic fibers. The anamorphic fibers can improve the fill-factor over circular fibers and also simplify the fabrication process (typically extrusion). Improvements in “Sweet spot” relationships are improved among sizes of anamorphic pixels, fiber size, fiber wedge magnifications, light redirector radius, and the like. Advantages of illumination along a preferred axis for non-square aspect ratio displays are provided for a given magnification. A desirable axis results in lower light attenuation in the fibers, thinner display structure, and lower structure weight. Collimated or semi-collimated illumination of fiber magnifier input face is provided to decrease attenuation from multiple interfacial reflections within the fibers. Larger fiber cross-sectional dimensions can also help decrease the number of reflections within fibers, and thus decrease attenuation.

Embodiments of the invention provide a rear projection imaging structure with a desirable and extremely thin form factor dramatically decreasing the required active area of image generators such as for Liquid Crystal Display panels. A high ambient light suppression is provided without having to apply anti-reflection coatings. Further, conventional rear projection components such as lenses and mirrors may be eliminated by using optical microstructures. A robust, sealed optical path that is resistant to misalignment and dust or dirt intrusion is provided, as well as a desirable low cost rear projection imaging module compatible with many illumination techniques. Yet further, embodiments of the invention may provide fiber light guides with low optical attenuation, and a one-dimensional fiber magnifier having a high fiber fill-factor and a small number of fiber light guides, by way of example.

### BRIEF DESCRIPTION OF DRAWINGS

For a fuller understanding of the invention, reference is made to the following detailed description, taken in connection with the accompanying drawings illustrating embodiments of the present invention, in which:

FIG. 1 is a diagrammatical illustration of one optical display system in keeping with the teachings of the present invention;

FIG. 2 is an exploded perspective view of a fiber optic light guide imager in keeping with the teachings of the present invention, illustrating magnifying in one dimension, with light redirecting structure and screen, by way of example;

FIG. 2A is a perspective view of one implementation of a non-square light guide imager with the image input disposed along a long input face;

FIG. 2B is a perspective view of an alternative embodiment of a light guide imager with the image input disposed along a short input face;

FIG. 3A is a cutaway cross-sectional view of an image generator, such as a liquid crystal display panel, incorporating full-structure anamorphic picture elements, without subpixels;

FIG. 3B is a cutaway cross-sectional view of an image generator, such as a liquid crystal display panel, having pre-distorted, anamorphic picture elements, commonly called pixels, arranged into color-primary subpixels;

FIG. 4A is a cutaway cross-sectional view of a fiber imager input face having fiber pitches appropriate for spatially sampling the image generator of FIG. 3A;

FIG. 4B is a cutaway cross-sectional view of a fiber imager input face having fiber pitches appropriate for spatially sampling the image generator of FIG. 3B;

FIG. 5 is a partial cutaway, cross-sectional side view of the bias-cut output face of a light guide imager as interfaced to a light redirecting structure;

FIG. 5A is a partial diagrammatical view of FIG. 5 illustrating a relationship between arcuate slab waveguides of one light redirecting structure and bias-cut waveguides of an array magnifier;

FIG. 6 is a cutaway, cross-sectional side view of a light redirecting structure integrated with an ambient-light-suppression screen element, the structural dimensions being somewhat exaggerated to more clearly illustrate the functional relationships of the components;

FIG. 6A is an enlarged section of FIG. 6 illustrating additional features for a saw tooth screen structure in keeping with the teachings of the present invention;

FIG. 7A is a diagrammatical illustration of a pixel array having a plurality of symmetric pixels arranged in a 4:3 aspect ratio;

FIG. 7B is a diagrammatical illustration of the pixel array of FIG. 7A after a shrinking of each pixel along a short dimension of the array to provide an anamorphic pixel array a modified 4:3 aspect ratio;

FIG. 7C illustrates one modification of a circular pixel to an oval, thus anamorphic pixel;

FIG. 8 is a partial cutaway cross-sectional view of fibers in a light guide imager input face;

FIG. 9A is a side cross-sectional view of a light guide imager indicating a one disposition of input and output faces that determines magnification factor; and

FIG. 9B is a side cross-sectional view of an alternative disposition of input and output faces that likewise determines magnification factor.

### DETAILED DESCRIPTION OF EMBODIMENTS

The present invention will now be described more fully with reference to the accompanying drawings in which embodiments of the invention are shown and described. It is to be understood that the invention may be embodied in many different forms and should not be construed as limited to the illustrated embodiments set forth herein. Rather, these embodiments are provided so that this disclosure may be thorough and complete, and will convey the scope of the invention to those skilled in the art.

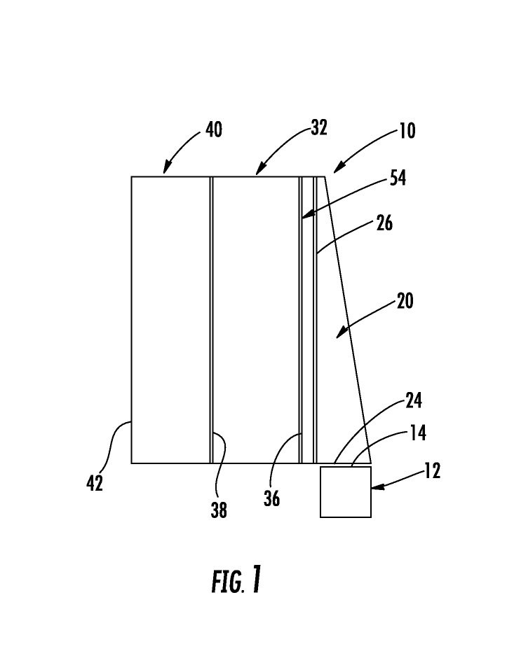

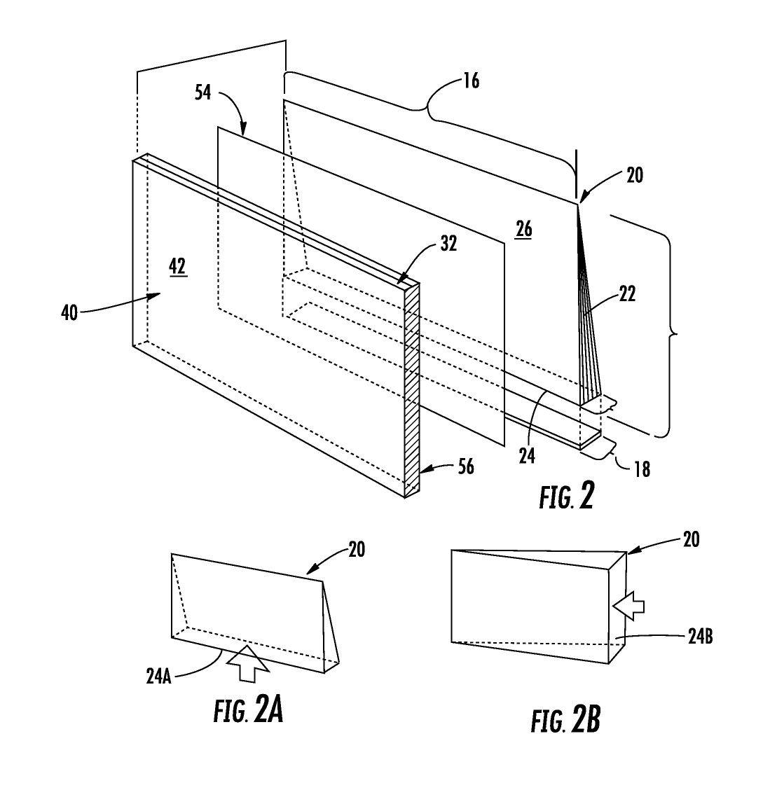

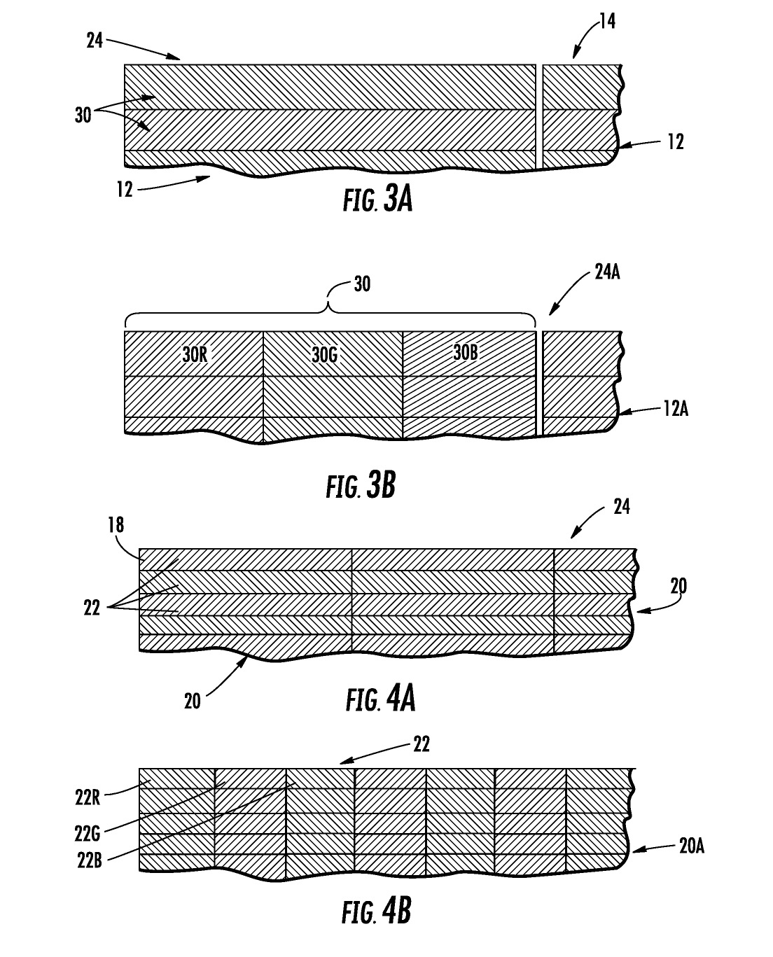

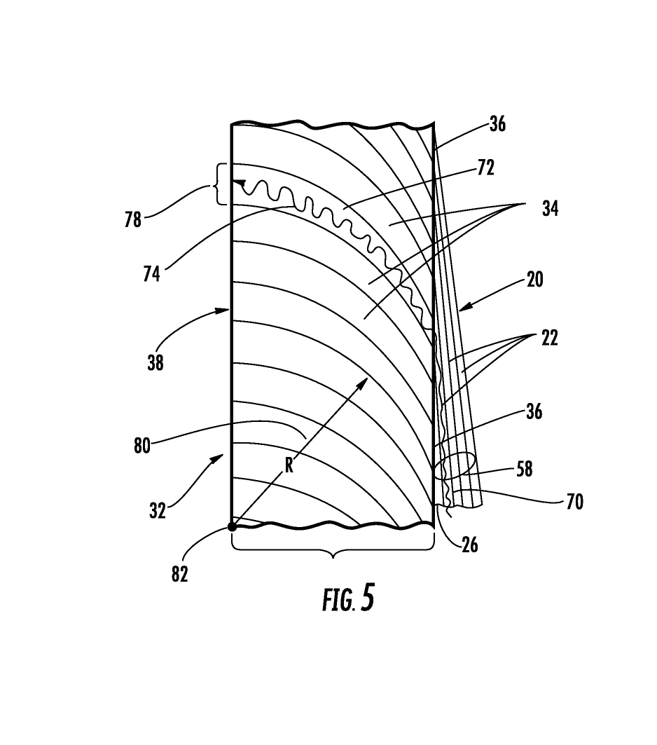

With reference initially to FIG. 1, one optical display system 10 in keeping with the teachings of the present invention is herein described by way of example to include an image generator 12 having an image output surface 14 for displaying an image. As illustrated with reference to FIGS. 2 and 3A, the image output surface 14 is defined by a long dimension 16 and a short dimension 18, wherein the image is formed by a plurality of discrete anamorphic picture elements 20 together forming the image, and wherein each picture element has its image spatially compressed along the short dimension 18 of the image output surface 14 and unchanged along the long dimension 16. With continued reference to FIGS. 1 and 2, and to FIG. 4A, an array magnifier 20 includes a plurality of anamorphic fiber optic light guides 22 extending from an input face 24 to an output face 26. The input face 24 is optically coupled to the image output surface 14 of the image generator 12 providing the plurality of discrete anamorphic picture elements 30. With each picture element 30 defined by the short and long dimensions 18, 16, the plurality of light guides 22 is aligned generally along corresponding axes of the long and dimensioned sides. The array magnifier 20 further includes each of the fiber optic light guides 20 bias-cut so as to form the output face 26 such that each fiber optic light guide is modified along the short dimension axes to provide a one-dimensional magnification to the anamorphic picture elements 30 being transmitted from the output face.

With continued reference to FIGS. 1 and 2, a light redirecting structure 32 is formed from a plurality of arcuate waveguide slab elements 34 arranged in a layered manner and extending from a first end 36 optically coupled to the output face 26 of the array magnifier 20, wherein each of the plurality of arcuate waveguide slab elements 34 extends so as to receive the image from the array magnifier and dimensioned to optically couple at least one line on the fiber optic light guides 22. The light redirecting structure 32 further includes a second end as an output face 38 formed by the plurality of arcuate waveguide slab elements 34. For the embodiment herein described, the output face 38 is generally within a plane approximately perpendicular to the image output surface 14 of the image generator 12.

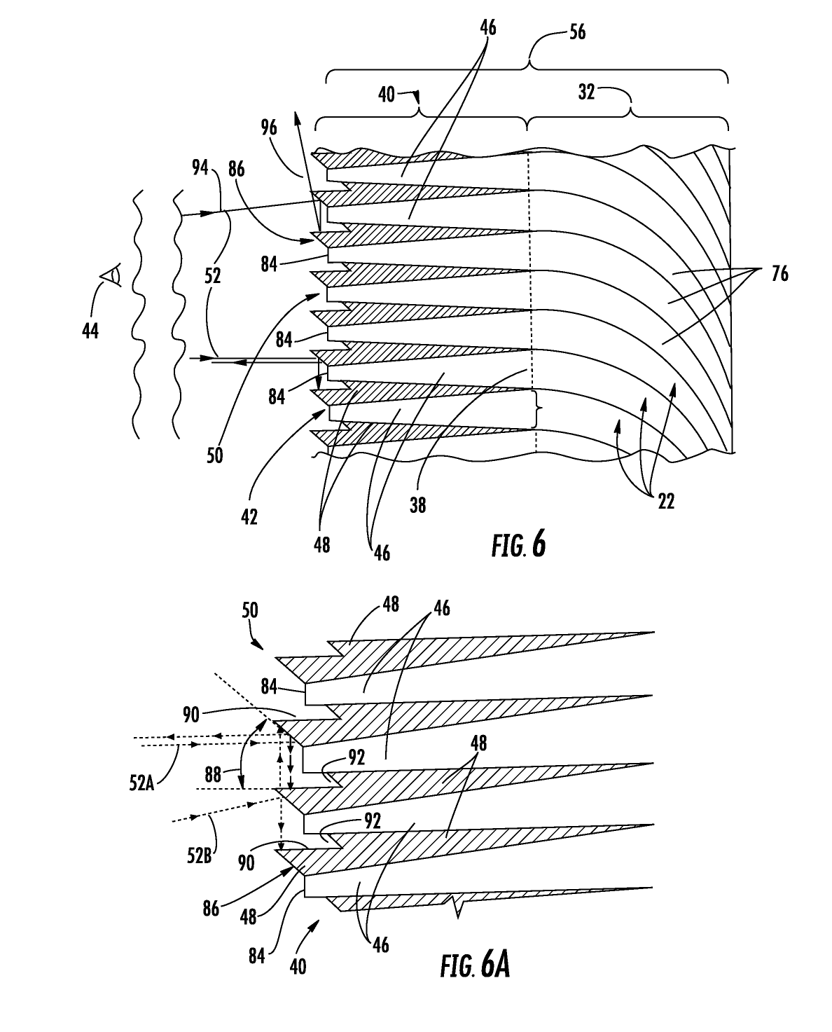

With reference again to FIG. 1, and for the embodiment herein described by way of example with reference to FIG. 6, an ambient light suppression screen 40 is integrally formed with the output face 38 of the light redirecting structure 32. The ambient light suppression screen 40 includes a screen viewing surface 42 for viewing the image by a viewer 44, wherein the screen surface is formed by a plurality of tapered slab waveguide portions 46 each extending from a corresponding one of the plurality of arcuate waveguide slab elements 34. In addition, a light absorbing material 48 is carried between each of the tapered slab wave waveguide portions 46 proximate the screen surface 42. The light absorbing material 48 includes at least one saw tooth styled edge portion 50 that reflects and absorbs ambient light 52 incident upon the screen surface 42.

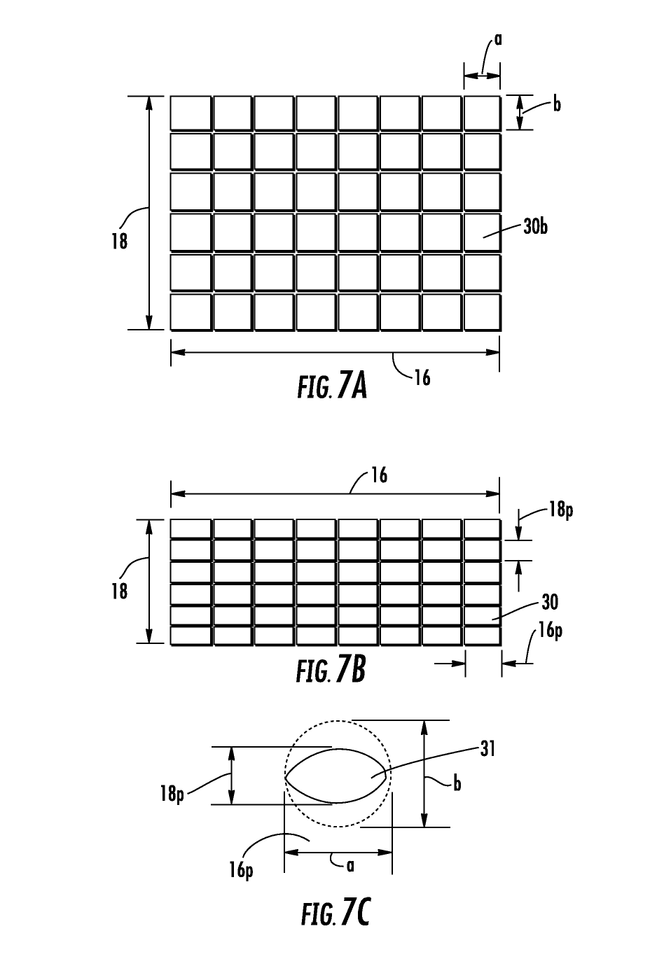

By way of continued example with reference to FIG. 2 and to FIG. 7B, the image generator 12 is anamorphic, wherein image information along the short dimension 18 has been dramatically shrunk, as compared to a format illustrated with reference to FIG. 7A, but the image information along the long dimension is unchanged from a final desired image format. The image generator 12 is typically a device having discrete picture elements 30, as earlier described and commonly called pixels. Due to the spatial compression of image information along one axis, the individual pixels have high aspect ratios and may also be called anamorphic, and defined as having short and long dimensions 16p, 18p as well. A liquid crystal display (LCD) panel is one example of a technology that may be usefully applied as the image generator 12. The anamorphic image generator 12 is optically and mechanically coupled to the input face 24 of the array magnifier 20 including the bias-cut fiber optic array.

As above described, the bias-cut fiber optic array magnifier 20 contains optical fibers as light guides 22. For the embodiment herein described, the light guides 22 intersect the output face 26 at an acute angle to form the one-dimensional fiber optic magnifier 20. As illustrated with reference again to FIGS. 1 and 2, an opto-mechanical coupling 54 is used for optically and mechanically coupling the output face 26 with the light redirecting structure 32 which in turn is optically and mechanically coupled to the ambient-light-suppression screen 40. Although the light redirecting structure 32 and the screen 40 may be fabricated as discrete entities, one embodiment includes them manufactured as an integrated structure 56, as illustrated with reference again to FIGS. 2 and 6.

With reference again to FIGS. 7A and 7B, a square to non-square example is herein diagrammatically illustrated for convenience, wherein a square pixel 30bhaving dimensions a×b is reshaped along the b dimension to become anamorphic pixel 30. While rectangular shapes are herein illustrated, it is understood by those skilled in the art that an oval pixel 31, as illustrated with reference to FIG. 7C may also be employed. It will be understood by those skilled in the art that other anamorphic shapes may be employed including a modifying of one anamorphic shape to another. For non-square output format images, commonly used in television transmissions, two basic configurations currently exist for a bias-cut fiber optic light guide imager: either the image is introduced along a longer input face 24A or along a shorter input face 24B, as illustrated with reference to FIGS. 2A and 2B. The longer input face configuration of FIG. 2A may be preferred to the shorter input face configuration of FIG. 2B.

With reference again to FIGS. 3A and 4A, and now to FIGS. 3B and 4B, a relationship between representative image generator formats and appropriate fiber array sampling structures are further illustrated, by way of example. FIG. 3B illustrates one format for a “pixilated” image generator 12A with color primary subpixels, typically Red 30R, Green 30G, and Blue 30B, forming the full pixel 30. Note that the pixel 30 has a pronounced aspect ratio, making it distinctly anamorphic. FIGS. 4A and 4B illustrate the fiber light guide array magnifier input face 24, 24A with discrete anamorphic fiber light guides 22 appropriately sized and spaced to sample the anamorphic image generator output face 24, 24A.

As earlier described, FIG. 3A illustrates an image generator surface 14 with representative pixels 30 having no subpixels, such as may be appropriate for a time-multiplexed color illumination scheme. The fiber light guide magnifier input face 24 of FIG. 4A incorporates a larger, discrete fiber 28 that is appropriate for sampling the larger pixels of image generator 12.

The pitch along each axis of a given fiber light guide cross-section conforms to a sampling rule known as the Nyquist theorem. At least one sampling element in a fiber matrix should be present for each element in an image generator pixel matrix according to the theorem, but image artifacts can occur if the matrices are not well-aligned. Therefore, a more dense fiber sampling matrix is required for most practical systems. By way of example, the sampling matrices illustrated with reference to FIG. 4A and FIG. 4B provide approximately two fiber light guide samples along each cross-sectional axis for the respective pixel structures of image generators 12, 12A.

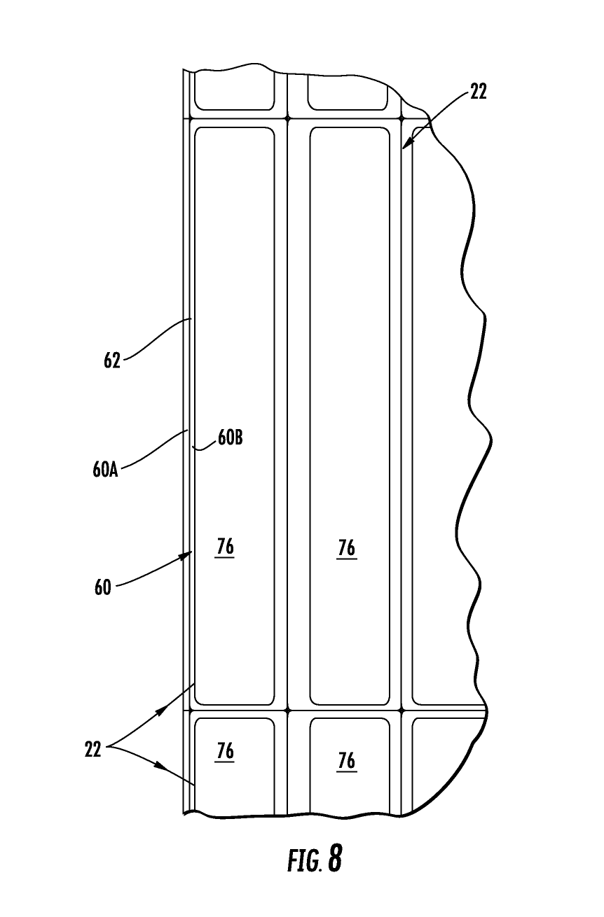

With regard to the array magnifier 20 and the light redirecting structure 32, reference is again made to FIG. 8 illustrating a partial cutaway cross-sectional view of individual anamorphic fibers 22. For the embodiment herein described by way of example, the fiber core 76 is formed from a high refractive index material such as a clear polymer. Cladding 60 is formed from a lower refractive index material. A thin light-absorbing structure 62 may be embedded within the cladding 60, between cladding portions 60A, 60B, for attenuating light rays incident upon the cladding 60. The thin structure 62 of black-filled polymer minimizes fiber-to-fiber crosstalk and improves overall contrast.

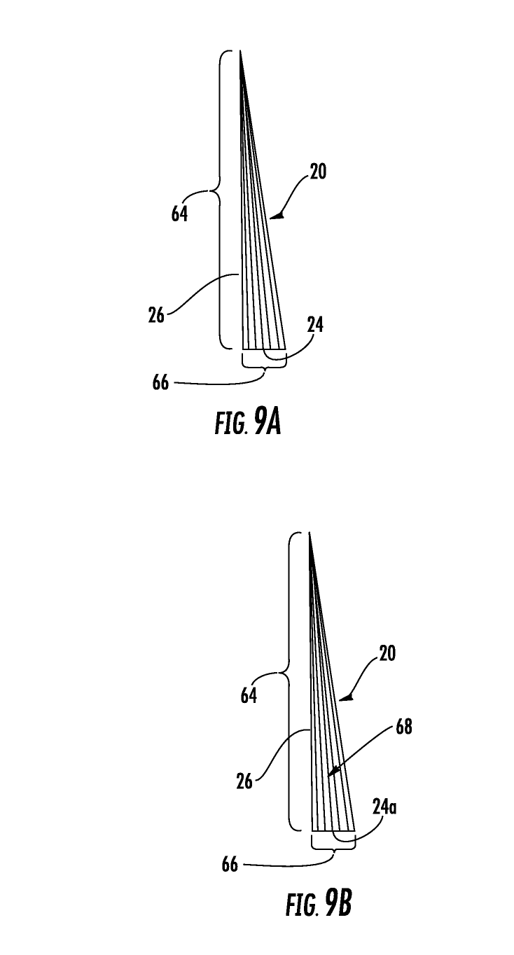

FIG. 9A and FIG. 9B illustrate alternative relationships between the fiber array input face 24 and output face 26 for establishing the one-dimensional magnification factor of the bias-cut fiber optic arrays herein described. By way of example, FIG. 9A illustrates the input face 24 nominally orthogonal to output face 26 with the magnification factor being given by the ratio of the vertical dimension 64 of output face 26 the horizontal or depth dimension 66 of input face 24. FIG. 9B illustrates an alternative input face 24a nominally orthogonal to the optical propagation axis 68 of the fibers 22 in the fiber optic array magnifier 20 with the magnification ratio similarly being given by the ratio of the vertical dimension 64 of output face 26 to the input face dimension 24a. The illustrations of FIG. 9A and FIG. 9B are merely part of a continuum of possible configurations of input and output faces, all, however, exhibiting a magnification factor defined by the ratio of output face to input face dimensions.

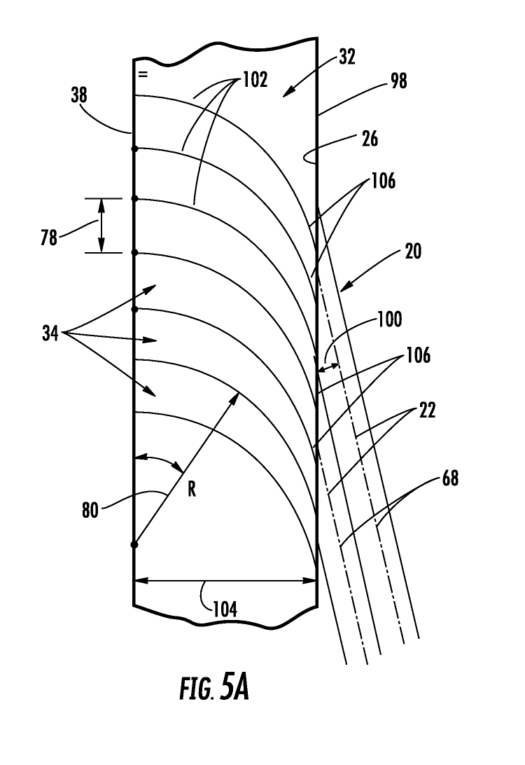

With reference again to FIG. 5, illustrating a partial cutaway, cross-sectional side view of the light redirecting structure 32 and the array magnifier 20 optically and mechanically coupling the output face 26 of the array magnifier to the light redirecting structure, abbreviated as LRS. The coupler 54 may include, for example, thermal bonding, curable polymer adhesives, or optical gels. However, the indices of refraction of array magnifier cores or light guides 22, and the LRS cores or waveguide slab elements 34 are closely matched to prevent reflections at the face 26. The LRS 32, as the name implies, serves to redirect representative incident light 70 along a curved path 72 until it intersects the output face 38 of the LRS 32. As earlier described, the LRS 32 comprises curved slab-type waveguide elements 34. Light 74 propagating within the waveguide elements 34 is unconstrained into or out of the plane of the drawing of FIG. 5, but is constrained within the plane of the cross-sectional drawing. Further, the light guides 22 of the fiber optic array magnifier 20 are fully constraining.

With reference again to FIG. 8, by way of example of the cladding 60 and core 76 form the waveguides of the LRS 32 and are typically fabricated using the same materials as fiber used for the array magnifier 20. With regard to the LRS 32, a pitch 78 of the waveguide elements 34 governs spatial sampling of the vertical, magnified image data at the fiber optic array magnifier output face 26. A radius of curvature 80 of the cladding 60 structures is slightly larger than the thickness of the LRS 32. The radius of curvature 80 is determined using parameters, including the pitch 78, a refractive index of the cladding 60 and core 76, and a desired angular extent of the confined light. The pattern of waveguide cladding 60 radii 80 within the LRS 32 structure is formed by displacing the center of curvature 82 incrementally by the desired pitch 78 along the output face 38. The output face 38 may be treated by various methods to diffuse emerging light and to suppress ambient light reflection toward the viewer 44, earlier described with reference to FIG. 6, including micro-patterning and anti-reflection coatings.

By combining the screen 40 earlier described with reference to FIGS. 1 and 6, with the LRS 32, the system 10 having a light guide structure including the magnifier 20 and LRS 32 with improved ambient light suppression is achieved. With continued reference to FIG. 6 and to FIG. 6A, the cladding 60 and core 76 of the LRS 32 are transitioned into a tapered slab waveguide portions 46 and the combination with the light absorbing material 48 form the ambient-light-suppression screen 40. The indices of refraction of the tapered core 76 and the light absorbing material 48 are typically the same as the corresponding elements in LRS 32. The front surface portion 84 of the screen viewing surface 42 of tapered slab waveguide portions 46 may be flat, as herein illustrated by way of example, may be curved, and/or micro-structured to control the distribution of emerging light and the reflection of ambient light. The output face 84 is juxtaposed to the saw tooth output face 86 of the saw tooth edge portion 50 of the light absorbing material 48. With reference to FIG. 6A, an interior acute angle 88 of approximately equal to 45 degrees is formed between a first surface 90 extending outwardly toward the viewer 44 and a second surface 92 oriented at the acute angle 88 to the first surface, thus allowing incident ambient light to be absorbed by multiple surfaces 90,92 of the absorbing material 48 though a multiple scattering. With continued reference to FIGS. 6 and 6A, representative ambient light paths 94, 96, 52A, 52B illustrate how light originating near the viewer 44 may be effectively attenuated via multiple reflections and absorptions and/or directed away from the viewer.

In operation, and with reference again to FIGS. 1 and 2, the light guide imager system 10 compactly magnifies and displays optical inputs that have been intentionally foreshortened along one dimension 18. The foreshortened dimension is restored to the original, desired size by the uni-axial magnification characteristic of the bias-cut fiber optic array magnifier 20. Image generators 12 such as liquid crystal display panels can be reduced in area by better than a factor of ten using this technique with correspondingly significant cost reductions. Such a fiber optic rear projection technique also eliminates conventional optical components such as lenses and mirrors while greatly reducing the thickness of the projection structure. The light redirecting structure 32 changes the direction of light rays 70 so that they are more easily observed, and the screen 40 reduces ambient light reflections and helps control the viewing angles of emitted images.

By way of further example, a nominally rectangular array of optical fibers having the input face 24 of about 1 to 2 meters by about 2 to 8 centimeters is optically coupled to the anamorphic image generator 12 such as a liquid crystal display (LCD) panel with overall dimensions similar to the fiber array input face. The anamorphic LCD image generator 12 may be formed by essentially shrinking, along one axis, the external dimensions of a panel having square picture elements, while maintaining the same number of picture elements along that axis. The individual picture elements, commonly known as pixels, then typically appear as high-aspect-ratio rectangular structures, as illustrated in FIGS. 3A and 3B, rather than square structures. Rectangular fiber structures are preferred to structures with near-unity aspect ratios due to fill-factor and fabrication considerations. The individual array fibers 22 may have rectangular, elliptical, or similarly-shaped, high-aspect-ratio cross sections, and have a pitch of about ⅓ to ⅔ of the pixel pitch of the anamorphic image generator 10 along respective axes, as desired. The pitch ratios of about ⅓ to ⅔ ensure that quality reproduction of the original image data is retained, according to a sampling theory by Nyquist, and also suppress an image artifact known as aliasing. Fiber pitch along the shorter dimension of the array is significantly smaller than the pitch along the longer dimension by a factor of approximately 4 to 30 times, depending upon the image generator architecture and the desired system magnification.

As above described with reference to the array magnifier 20, and a herein further described with reference to FIG. 5A, the output face 26 is formed by a linear bias cut 98 beginning parallel to the long axis of the input face 26 and proceeding at an acute angle 100 with respect to the light propagation axis 68 of the fiber optic light guides 22 of the array magnifier 20. As the angle 100 is made more acute, the magnification factor of the imager is increased. As discussed, the ratio of the bias cut output face dimension to the input face dimension determines the magnification factor. Since the angle formed between the output face and incident light is acute, total internal reflection may trap much of the incident light within the fiber array structure if the output face encounters a medium with an optical index of refraction differing significantly from the optical index of fiber optic core. There is therefore a need to optically index match the cores of the optical fibers to help overcome the internal reflection at the bias cut face. Additionally, it is desirable for the emerging light rays 70 to be redirected such that they propagate in a direction generally orthogonal to the surface of the bias cut face 26 of the array magnifier 20.

With continued reference to FIG. 5A, the LRS 32 may be an array of the slab-type optical waveguides 34 having well-defined, arc-like cross sections, as earlier described. The angular extent of the arcs 102 of each slab element 34 is controlled by the system magnification, but will be slightly less than 90 degrees for one embodiment as herein described by way of example. As a result, the dimension of width 104 of the LRS 32 will be less that the dimension for the radius of curvature 80 for that particular structure 32. As above described, the radius of curvature 80 of the arcs 102 is determined by the pitch 78 along the face 38 as well as the light cone to be contained by the curved light guides 32. One relationship between the width 104 of the LRS 32 and the radius of curvature 80 may be expressed as: width of the LRS=radius of curvature×square root(1−system magnification̂−2). Additionally, the angular extent of the arcs 102, beginning at the face 38 and optimally interfacing with the bias cut face 26 of array magnifier 20 may be expressed in a degree measurement as: an angular extent=90−an angle whose cosine is a square root of (1−system magnification̂−2). Further, the arrangement of the waveguide slab elements 34 will be such that the arcs 102 tangentially intersect (indicated with numeral 106) the light propagation axes 68 or are within a plane parallel to the axes. By way of further example, if a magnification of the array magnifier 20 were 10×, the total angular arc length 102 (in degrees) to optimally couple the light redirecting structure 32 to the array magnifier 20 would be 90 degrees less the angle whose cosine is the square root of (1.0-0.01) or Angle Theta (θ)=90−5.74=84.26 degrees for the arc length 102. This is by way of example for a system in which the image generator plane is orthogonal to the light guide axes, but similar relationships may be derived for other input configurations.

One method for bounding the radius may be found in Applied Optics, Volume 2, page 191, by Leo Levi, 1980, John Wiley & Sons, publishers, the disclosure of which is herein incorporated by reference. By way of example, the pitch 78 of the light guide cladding arcs may be about ⅓ to ⅔ of the pitch of the fibers along the magnified axis of the fiber array face 26. The radius of curvature may nominally be 2 to 4 millimeters for light guides made of polystyrene and acrylic, supporting an F/3 light cone, and with a pitch of about 100 micrometers.

With reference again to the screen 40 above described with reference to FIGS. 6 and 6A, the saw tooth edge portion 50 may be oriented such that a major portion of ambient light incident on the screen may encounter three reflections before returning toward the viewer/observer or in some cases reflected in a direction approximately orthogonal to the observer, constituting a near-infinite ambient light sink. Ambient light propagating into the interior of the light trap structure is absorbed by the light absorbing material 48 and is no longer available to degrade image contrast. If each reflection averages about 6 percent, a reasonable value for reflections from acrylic, then after three reflections the aggregate reflected ambient light would be approximately 0.02%. This value is about 250 times better than the unmodified output face value of 5% and about 25 times better than typical values of about 0.5% for anti-reflection coated surfaces. The preceding values do not include reflection from the output apertures but do give a representative estimate of the effectiveness of the light trap technique. The front surface portion 84 (output aperture face area) may be significantly decreased by tapering and extending the cores and claddings of the LRS 32, as above described until they just emerge from the screen 40. The degree of taper is controlled by the relative indices of core and cladding as well as the angular nature of the light incident at the beginning of the taper and the desired output light spread. The light spread emerging from the output face may also be controlled by varying the surface curvature, or by micro-structuring the surface. Additionally, scattering or diffusing materials may be included within the core of the LRS 32 and the core of the tapered areas.

The light redirecting structure 32, the tapered light guide 46 and the saw tooth screen structure 50 may all be integrated into a single construct to facilitate manufacturing and assembly. A tri-component polymer extrusion system with appropriate die structures and post-extrusion embossing is one means of fabricating the integrated structure. A similar extrusion system with different die structures may be used to fabricate the fiber optic array magnifier 20. Additional common post-extrusion processing techniques such as cutting and polishing may also be applied to the fabrication.

The light guide imager exhibits high ambient light suppression and a very thin form factor while dramatically reducing the area of active image generators such as liquid crystal display panels. It is suitable for use with several flat panel display illumination architectures. By way of example, Illumination schemes may include:

Hot cathode, aperture fluorescent lamp with short-focal-length Fresnel collimating lens and reflective polarizer for polarization reuse;

Conventional projection lamps with long-focal-length Fresnel collimating lens and reflective polarizer;

Spatially separated, color segregated Light Emitting Diodes with reflective polarizer used with long-focal-length Fresnel collimating lens and lenslet array to spatially distribute color primary illumination to image generator subpixels;

Spatially integrated, color segregated Light Emitting Diodes with reflective polarizer used with long-focal-length Fresnel collimating lens and LEDs time multiplexed to distribute color primary illumination to image generator pixels;

Illumination of input face of fiber magnifier with collimated or nearly-collimated light, decreasing the number of fiber wall interactions and thus decreasing the light attenuation through the fibers;

Controlling the polarization direction of light entering the input face of the fiber magnifier, and maintaining the polarization up to the output aperture of the imager, for selective minimization of internal reflection at the output aperture interface according to the Fresnel equations;

Modulation of the amplitude of illumination sources for light valve type image generators to follow the average video scene illumination, to increase the effective dynamic range of the output image; and/or

Modulation of the pulse width of illumination sources for light valve type image generators to decrease motion image artifacts associated with whole frame display of image data.

Many modifications and other embodiments of the invention will come to the mind of one skilled in the art having the benefit of the teachings presented in the foregoing descriptions and the associated drawings and photos. Therefore, it is to be understood that the invention is not to be limited to the specific embodiments disclosed, and that modifications and alternate embodiments are intended to be included within the scope of the claims supported by this specification.

That which is claimed is:

1. An optical display system comprising:
an array magnifier having a plurality of anamorphic fiber optic light guides extending from an input face to an output face of the array magnifier, the input face dimensioned for optically coupling to an image generator providing a plurality of discrete anamorphic picture elements thereto, wherein each picture element is defined by a short dimension and a long dimension, and wherein each of the plurality of light guides is generally aligned along corresponding long and short axes thereof, the array magnifier further having a bias-cut output face such that each fiber optic light guide is modified along the short dimension so as to provide a one-dimensional magnification to each of the anamorphic picture elements; and
a light redirecting structure having a plurality of arcuate waveguide slab elements arranged in a layered manner and extending from a first end optically coupled to the output face of the array magnifier, wherein each of the plurality of arcuate waveguide slab elements extends so as to receive an image from the image generator as modified by the array magnifier and each dimensioned to optically couple to the plurality of fiber optic light guides, the light redirecting structure further having an output face formed by the plurality of arcuate waveguide slab elements.

2. A system according to claim 1, wherein the waveguide slab elements include arc-like cross sections, and wherein the waveguide slab elements tangentially intersect propagation axes of the plurality of light guides of the array magnifier.

3. A system according to claim 1, wherein a radius of curvature of the waveguide slab elements is greater than an effective width dimension of the light redirecting structure, and wherein the radius of curvature is determined by a pitch for adjacent slab elements along the output face and a light cone to be contained by the light guide slab elements.

4. A system according to claim 1, wherein the input face of the array magnifier is generally orthogonal to the output face thereof.

5. A system according to claim 1, further comprising an opto-mechanical coupler interposed between the output of the array magnifier and the first and of the light redirecting structure.

6. A system according to claim 1, wherein the coupling of the first end of the light redirecting structure to the output face of the array magnifier includes at least one of a thermal bonding, a curable polymer adhesive, and an optical gel.

7. A system according to claim 1, wherein magnification for an image at the input face to the output face of the array magnifier is determined by a ratio between the modified short dimension of the output face to the short dimension of the input face.

8. A system according to claim 1, wherein the indices of refraction for each core of the fiber optic light guides of the array magnifier and each core of the waveguide slab elements are sufficiently matched for minimizing reflections at the output faces of the array magnifier.

9. A system according to claim 1, wherein each of the plurality of fiber optic light guides of the array magnifier and the wave guide slab elements comprise a core carried within a cladding.

10. A system according to claim 9, wherein a radius of curvature for each of the arcuate slab elements of the light redirecting structure is governed by a pitch for adjacent slab elements and a light distribution at the input face thereof.

11. A system according to claim 9, wherein the core is formed from a clear polymer and wherein an index of refraction for material forming the core is substantially greater than the index of refraction for material forming the cladding.

12. A system according to claim 9, wherein the cladding further comprises a light absorbing material sandwiched between inner and outer cladding layers.

13. A system according to claim 1, further comprising an ambient light suppression screen optically coupled with the output face of the light redirecting structure, the ambient light suppression screen having a screen surface for viewing the image by a viewer, wherein the screen surface is formed by a plurality of slab waveguides each extending from a corresponding one of the plurality of arcuate waveguide slab elements, and wherein a light absorbing material is carried between each of the slab waveguides proximate the screen surface, the light absorbing material having at least one saw tooth styled edge portion scattering ambient light incident upon the screen surface away from the viewer.

14. A system according to claim 13, wherein at least one saw tooth styled edge portion of the light absorbing material comprises a first surface extending outwardly toward the viewer and a second surface oriented at an acute angle to the first surface, thus allowing incident ambient light to be absorbed by multiple surfaces of the absorbing material though a multiple scatter on surfaces thereof.

15. A system according to claim 14, wherein the acute angle is 45°.

16. A system according to claim 13, wherein the at least one saw tooth styled edge portion comprises a plurality of teeth included between adjacent slab waveguides.

17. A system according to claim 13, wherein a substantial portion of the slab waveguides includes tapered end portions.

18. A system according to claim 1, further comprising an image generator having an image output surface displaying an image, the image output surface defined by the long dimension and the short dimension, wherein the image is formed by a plurality of discrete anamorphic picture elements together forming the image, and wherein each picture element has its image spatially compressed along the short dimension of the image output surface and unchanged along the long dimension.

19. A system according to claim 18, wherein the image generator comprises a liquid crystal display.

20. A system according to claim 18, wherein the discrete picture elements comprise pixels.

21. A system according to claim 18, wherein each of the plurality of discrete anamorphic picture elements comprises a plurality of discrete color elements.

22. A system according to claim 21, wherein the plurality of discrete color elements comprise red, green and blue subpixels.

23. An optical display system comprising:
an image generator having an image output surface displaying an image, the image output surface defined by a long dimension and a short dimension, wherein the image is formed by a plurality of discrete anamorphic picture elements, and wherein each picture element has its image spatially compressed along a short dimension of the image output surface and unchanged along a long dimension thereof;
an array magnifier having a plurality of fiber optic light guides extending from an input face to an output face, the input face being optically coupled to the image output surface of the image generator, the array magnifier further having a bias-cut output face such that each fiber optic light guide is modified along the short dimension so as to provide a one-dimensional magnification to each of the anamorphic picture elements; and
a light redirecting structure having a plurality of arcuate waveguide slab elements arranged in a layered manner and extending from a first end optically coupled to the output face of the array magnifier, wherein each of the plurality of arcuate waveguide slab elements extends so as to receive an image from the image generator as modified by the array magnifier and each dimensioned to optically couple to the plurality of fiber optic light guides, the light redirecting structure further having an output face formed by the plurality of arcuate waveguide slab elements; and
an ambient light suppression screen integrally formed with the output face of the light redirecting structure, the ambient light suppression screen having a screen surface formed by a plurality of tapered slab waveguides each extending from a corresponding one of the plurality of arcuate waveguide slab elements, and wherein a light absorbing material is carried between each of the tapered slab wave waveguides proximate the screen surface, the light absorbing material having at least one saw tooth styled edge portion providing multiple scattering and thus multiple absorption of ambient light incident upon the screen.

24. A system according to claim 23, wherein the image generator comprises polychromatic a liquid crystal light valve providing the picture elements including spatially integrated, color segregated light emitting diodes (LEDs) having a reflective polarizer used with a long-focal-length Fresnel collimating lens, and wherein the LEDs are time multiplexed to distribute color primary illumination to the picture elements.

25. An optical display system comprising:
an array magnifier having a plurality of fiber optic light guides extending from an input face to an output face, the input face dimensioned for being optically coupled to an image output surface of an image generator, the array magnifier further having a bias-cut output face such that each fiber optic light guide is modified along the short dimension so as to provide a one-dimensional magnification to each of the anamorphic picture elements;
a light redirecting structure having a plurality of arcuate waveguide slab elements arranged in a layered manner and extending from a first end optically coupled to the output face of the array magnifier, wherein each of the plurality of arcuate waveguide slab elements extends so as to receive the image from the array magnifier and dimensioned to optically couple at least one line on the fiber optic light guides, the light redirecting structure further having an output face formed by the plurality of arcuate waveguide slab elements, wherein a light absorbing material is carried between each of the slab elements, the light absorbing material having a saw tooth styled edge portion providing multiple scattering and thus multiple absorption of ambient light incident upon the screen surface.

26. A system according to claim 25, wherein the output face of the array magnifier lies generally within a plane approximately perpendicular to the input face.

27. A system according to claim 25, wherein dimensions and aspect ratios of the optical fibers are sized to accommodate a desired optical resolution of an image generator according to spatial Nyquist sampling requirements for a given image acuity.
